(19) United States
(12) Patent Application Publication
(10) Pub. No.: US 2008/0283634 A1
(43) Pub. Date: Nov. 20, 2008

(54) Device for the Injection of Fuel Into the Combustion Chamber of an Internal Combustion Engine

(75) Inventor: Jaroslav Hlousek, Golling (AT)

Correspondence Address: FITCH, EVEN, TABIN & FLANNERY, P. O. BOX 18415, WASHINGTON, DC, 20036, US

(73) Assignee: Robert Bosch GmbH, Stuttgart-Feuerbach (DE)

(21) Appl. No.: 11/659,497

(22) PCT Filed: Aug. 5, 2005
(86) PCT No.: PCT/AT05/00318

§ 371 Date: Feb. 6, 2007

(30) Foreign Application Priority Data
Aug. 6, 2004 (AT) A 1351/2004

(51) Int. Cl. F02M 51/06

(52) U.S. Cl. 239/585.5

(57) ABSTRACT

In a device for the injection of fuel into the combustion chamber of an internal combustion engine, including an injector nozzle (5) and a nozzle needle (7) guided in a longitudinally displaceable manner within the injector nozzle (5), which nozzle needle (7) is at least partially surrounded by a nozzle prechamber (8) and, for the control of its opening and closing movements, capable of being pressurized in the axial direction by the pressure prevailing in a control chamber (12) filled with fuel, a supply line runs into the control chamber (12) and a discharge line (19) in which a magnetic control valve (16) is arranged leads away from the control chamber (12). The supply line to the control chamber (12) is guided through at least one bore (14) of the nozzle needle (7), which communicates with the nozzle prechamber (8) via a supply throttle (15). Between the control chamber (12) and the nozzle prechamber (8) is arranged a further supply throttle (35), whose passage cross-section during the pass of at least a partial stroke of the nozzle needle (7) is changeable and/or closable as a function of the stroke of the nozzle needle (7).

The invention relates to a device for the injection of fuel into the combustion chamber of an internal combustion engine, including an injector nozzle and a nozzle needle guided in a longitudinally displaceable manner within the injector nozzle, which nozzle needle is at least partially surrounded by a nozzle prechamber and, for the control of its opening and closing movements, capable of being pressurized in the axial direction by the pressure prevailing in a control chamber filled with fuel, wherein a supply line runs into the control chamber and a discharge line in which a magnetic control valve is arranged leads away from the control chamber, wherein the supply line to the control chamber is guided through at least one bore of the nozzle needle, which communicates with the nozzle prechamber via a supply throttle.

A device of this type is, for instance, known from EP 921301 B1 and US 2002/125339 A1.

Devices of this type, which are also referred to as injectors, are frequently used for common-rail systems to inject diesel fuels into the combustion chambers of diesel engines and are usually configured in a manner that the opening and closing of the injection cross-sections are performed by a nozzle needle which is guided by a shank in a longitudinally displaceable manner within a nozzle body. The control of the movement of the nozzle needle is realized via a magnetic valve. The nozzle needle is pressurized on both sides with the fuel pressure and by a pressure spring acting in the closing direction. On the rear side of the nozzle needle, i.e. on its side facing away from the nozzle needle seat, a control chamber is provided, in which fuel under pressure pressurizes the nozzle needle in the closing direction, thus pressing the nozzle needle onto the needle seat or valve seat.

The control valve, which may for instance be designed as a magnetic valve, releases a discharge line leading away from the control chamber in order to cause a drop of the fuel pressure prevailing in the control chamber, whereupon the nozzle needle is lifted from its seat against the force of the spring due to the fuel pressure prevailing on the other side, thus releasing the passage of fuel to the injection openings. The opening speed of the nozzle needle is determined by the difference between the flow rate in the supply line to the control chamber and the flow rate in the discharge line from the control chamber, wherein a throttle is each arranged both in the supply and in the discharge lines to respectively determine said flow rates.

With conventional injectors, both the supply line to the control chamber and the discharge line from the control chamber are formed in an intermediate plate delimiting the upper side of the control chamber and, hence, arranged in the immediate vicinity of the magnetic control valve. The use of heavy oil as fuel, however, involves a number of difficulties with conventional injectors. Heavy oils have high viscosities, with heating up to 150° C. being required to lower said viscosities. This will cause the injector to be heated to beyond the usual extent, which will raise problems, particularly in the region of the magnetic valve. The arrangement of the supply line leading to the control chamber, and the discharge line leading away from the control chamber, in the immediate vicinity of the magnetic valve, in particular, will lead to intense heating and, hence, jeopardization of, or even damage to, this component. For this reason, it has already been proposed to guide the supply line to the control chamber through at least one bore of the nozzle needle, which communicates with the nozzle prechamber via a supply throttle. Due to the fact that the supply line to the control chamber is guided through at least one bore of the nozzle needle, the control chamber is supplied with fuel from below, i.e. from the control chamber side located opposite the discharge line. The control chamber will, thus, be perfused in the axial direction such that improved flow conditions will result. Due to the fact that the supply duct to the control chamber is not arranged in the intermediate plate but via a nozzle needle bore, the heat development to be observed with the use of heavy oil will be kept away from the region of the magnetic control valve and relocated in the region of the nozzle needle, which is in contact with the heated heavy oil anyway. The bore of the nozzle needle, through which the supply line is guided to the control chamber, communicates with the nozzle prechamber via a supply throttle so as to provide a number of optimization options for the control of the opening and closing movements of the nozzle needle.

A similar arrangement of the supply throttle is also known from EP 1088985 A1. In addition to a central supply throttle, a further supply throttle is provided in the nozzle needle. The mode of functioning is such that the central supply throttle is abruptly closed as the nozzle needle is opened, and hence becomes inactive. At the beginning of the nozzle needle closing movement, only the supply throttle becomes active, with the nozzle needle closing movement starting slowly until the radial flow to the supply throttle is feasible via a sufficiently large cross section so as to cause a quick needle closure.

In addition to solving the problems entailed by the use of heavy oil, the present invention aims to arrange the supply line to the control chamber in a manner as to allow for the realization of a particularly simple structure and the optimized control of the opening and closing movements of the nozzle needle.

To solve this object, it is provided according to the invention that, between the control chamber and the nozzle prechamber, a further supply throttle is arranged, whose passage cross-section during the pass of at least a partial stroke of the nozzle needle is changeable and/or closable as a function of the stroke of the nozzle needle, said further supply throttle in a preferred manner being opened during the pass of at least a partial stroke of the nozzle needle and closed outside the said least partial stroke. By providing an additional supply throttle to the control chamber, the amount of fuel reaching the control chamber per unit time can be regulated, with an influence on the flow rate being feasible as a function of the stroke of the nozzle needle. As an increased amount of fuel is flowing into the control chamber per unit time, the movement of the nozzle needle is being slowed down at a constant discharge from the control chamber. Inversely, the movement of the nozzle needle is accelerated at a reduced additional flow into the control chamber. In doing so, continuous influence on the passage cross-section of the further supply throttle can, for instance, be taken at least during the pass of a partial stroke such that said further supply throttle will be opened at a pass of at least a partial stroke of the nozzle needle and closed outside said at least partial stroke. This influence on the opening and/or closing movements of the nozzle needle can be realized in various ways, it being preferably provided that said further supply throttle is opened over a partial stroke, departing from the opened position of the nozzle needle. This means that the supply throttle, departing from its closed position, is initially closed over a partial stroke and opened as far as to its opened position over a first further partial stroke. This means that the opening of the needle is decelerated towards the end of the opening movement such that the nozzle needle will hit the intermediate plate with a reduced impact force, which will reduce the wear of the contact surfaces. During the closing procedure of the nozzle needle a slower touchdown of the nozzle needle on the nozzle needle seat will consequently occur, thus likewise producing reduced wear,

Also a reverse configuration, in which the needle opening procedure occurs at first slowly and then in an accelerated manner, can bring advantages to a number of objectives, as will be described below by way of an exemplary embodiment.

The configuration is advantageously further developed such that the nozzle needle is guided in a control sleeve and said further supply throttle is formed by a throttle bore running into the bore of the nozzle needle and a supply bore provided in the control sleeve, wherein the throttle bore and the supply bore enter into alignment during the pass of a partial stroke of the nozzle needle, wherein it is additionally provided that the supply bore runs into an annular groove provided on the inner periphery of the control sleeve and can be brought into alignment with an annular groove provided on the outer periphery of the nozzle needle and communicating with the throttle bore. This configuration effects a release or closure of said further supply throttle by the axial movement of the nozzle needle relative to the control sleeve. In this respect, the control sleeve may comprise a supply bore which can be brought into alignment with the throttle bore, or the throttle bore can directly cooperate with the lower edge of the control sleeve. In the latter case, the configuration is devised such that the throttle bore runs into an annular groove provided on the outer periphery of the nozzle needle, which annular groove will be closed by the lower edge of the control sleeve after having travelled a first partial stroke.

In the following, the invention will be explained in more detail by way of an exemplary embodiment schematically illustrated in the drawing. Therein:

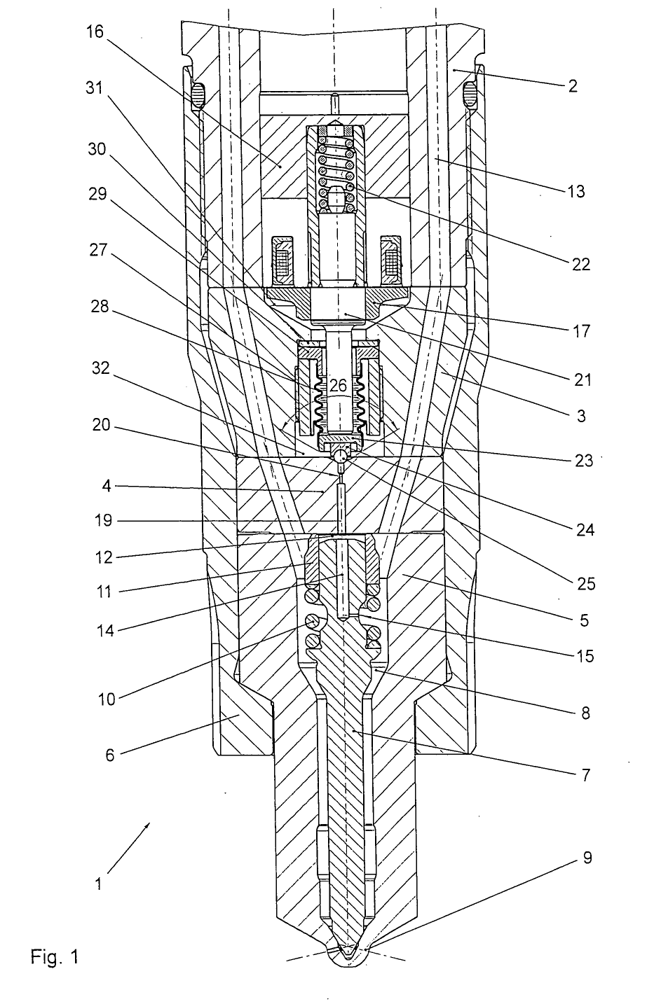

FIG. 1 is a cross section through an injector;

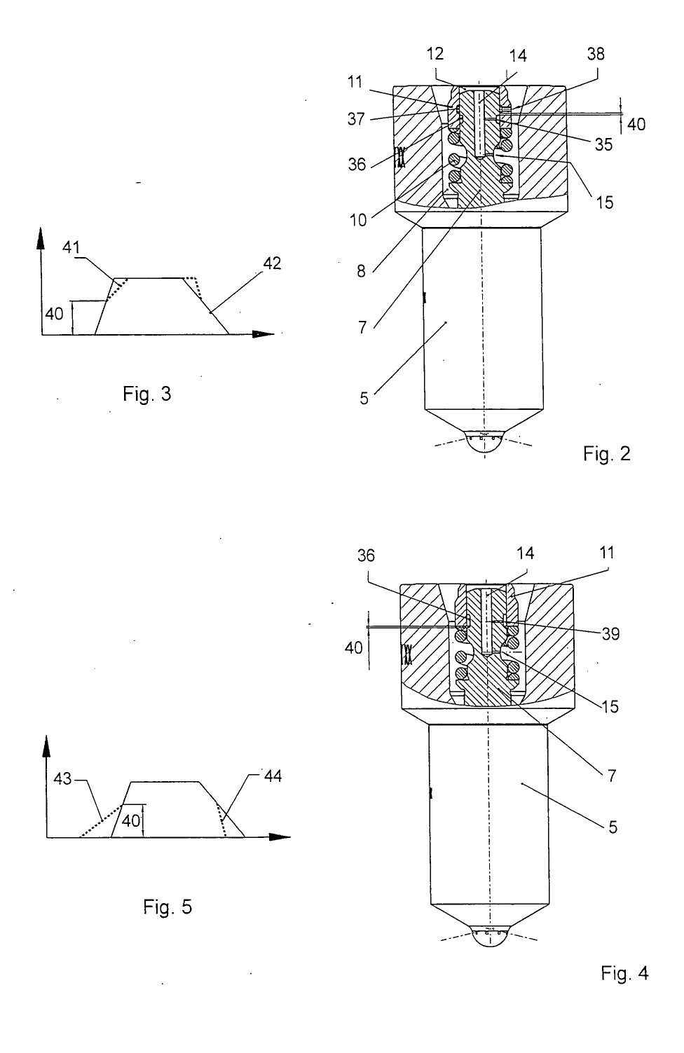

FIG. 2 is a partial cross section in an enlarged illustration, of the lower portion of the injector in a modified configuration;

FIG. 3 illustrates the curve of the needle stroke as a function of time in a configuration according to FIG. 2;

FIG. 4 illustrates a further modified embodiment of the injector; and

FIG. 5 illustrates the curve of the needle stroke as a function of time according to the configuration of FIG. 4.

FIG. 1 depicts the structure of an injector for a common-rail injection system of large diesel engines. The injector 1 comprises an injector body 2, a valve body 3, an intermediate plate 4 and an injector nozzle 5, which are held together by a nozzle clamping nut 6. The injector nozzle 5 comprises a nozzle needle 7, which is guided in a longitudinally displaceable manner within the nozzle body of the injector nozzle 5 and has several open spaces through which fuel can flow from the nozzle prechamber 8 to the tip of the needle. As the nozzle needle 7 is opened, fuel is injected into the combustion chamber of the internal combustion engine through several injection openings 9.

The nozzle needle 7 comprises a collar to support a compression spring 10 which, by its upper end, presses a control sleeve 11 against the lower side of the intermediate plate 4. The control sleeve 11, the upper end face of the nozzle needle 7 and the lower side of the intermediate plate 4 delimit a control chamber 12. The pressure prevailing in the control chamber 12 is relevant to the control of the movement of the nozzle needle. Via the fuel supply bore 13, the fuel pressure, on the one hand, becomes effective in the nozzle prechamber 8, where it exerts a force in the opening direction of the nozzle needle 7 via the pressure shoulder of the nozzle needle 7. On the other hand, it acts in the control chamber 12 via the bore 14 and the supply throttle 15 and, assisted by the force of the pressure spring 10, holds the nozzle needle 7 in its closed position.

In the closed position of the injector, the magnet armature 17 of the magnetic valve is pressed downwards by the pressure spring 22 and, in turn, presses the valve ball 25 via the pressure pin 21, the lower bellows plate 23 and the ball plate 24 into the conical seat 26 provided in the intermediate plate 4. The upper bellows plate 29 is mounted tightly to the valve body 3 by a screw connection 27 via an adjustment disc 30. The metallic spring bellows 28 is sealingly attached to the upper 29 and lower bellows plate 23 by welding or gluing, providing sealing between the magnetic valve space 31 and the discharge space 32, on the one hand, and causing the reliable contact between the pressure pin 21 and the bellows plate 23, on the other hand.

By activating the electromagnet 16, the magnet armature 17 is lifted along with the pressure pin 21 connected therewith, while the valve seat 26 is opened. The fuel from the control chamber 12, via the discharge line 19, flows through the discharge throttle 20 and the open valve seat 26, into the pressureless discharge channel (not illustrated), which, along with the drop of the hydraulic force exerted on the upper end face of the nozzle needle 7, causes the opening of the nozzle needle 7. The fuel then reaches the combustion chamber of the motor through the injection openings 9. In the opened state of the injector nozzle 5, high-pressure fuel flows into the control chamber 12 through the supply throttle 15 and, at the same time, in a larger amount, off through the discharge throttle 20. In doing so, the so-called control amount is pressurelessly discharged into the discharge channel, i.e. drawn off the rail in addition to the injection amount. The opening speed of the nozzle needle 7 is determined by the difference in the flow rates between the supply and discharge throttles 15, 20.

As the activation of the electromagnet 16 is terminated, the magnet armature 17 is pressed downwards by the force of the pressure spring 22 and the valve ball 25 via the conical seat 26 closes the discharge path of the fuel through the discharge throttle 20. Via the supply throttle 15, the fuel pressure is again built up in the control chamber 12, generating a closing force that exceeds the hydraulic force exerted on the pressure shoulder of the nozzle needle 7 reduced by the force of the pressure spring 10. As a result, the nozzle needle 7 closes the path to the injection openings 9 and concludes the injection procedure.

In accordance with the invention, the supply throttle 15 in the injector illustrated in FIG. 1 is not provided in the intermediate plate 4, but is arranged within the nozzle needle 7. Together with the bore 14, it provides a permanently open connection between the nozzle prechamber 8 and the control chamber 12. The advantage of arranging the supply throttle 15 and the discharge throttle 20 in different structural components resides in the simpler adaptation to different requirements of motor concepts and in the more cost-effective exchange at a possibly occurring wear on one of the two throttle bores.

FIG. 2 depicts a partial cross section in the region of the control sleeve 11 and the upper region of the nozzle needle 7. The nozzle needle 7, in addition to the supply throttle 15, comprises a further supply throttle 35, which opens into an annular groove 36 provided in the nozzle needle 7, which, after having travelled a partial stroke 40 of the nozzle needle 7, will correspond with the annular groove 37 provided in the control sleeve 11 and, hence, open an additional connection from the nozzle prechamber 8 to the control chamber 12 via the supply bore 38 provided in the control sleeve 11. As a result, an increased amount of fuel will flow into the control chamber 12, and the opening movement of the nozzle needle 7 will be slowed down. FIG. 3 illustrates the effect of this arrangement on the needle stroke curve. It shows the needle movement over time. The continuous line indicates the needle movement with an arrangement according to FIG. 1, the broken line that with the modified arrangement according to FIG. 2. Due to the delay in the opening of the needle, a flatter rise 41 of the needle movement is reached after the partial stroke 40 has been run through. The impact of the nozzle needle 7 on the intermediate plate 4 too occurs at a lower impact force. The wear of the contact surfaces will, thus, be reduced. Another effect of the arrangement consists in that, upon closure of the controlled supply throttle 35 during the closing procedure of the nozzle needle 7, the fuel supply to the control chamber 12 will merely take place through the opening of the supply throttle 15 such that the closing procedure will be slowed down. The effect on the movement of the needle is shown by the line representing the flatter drop 42 in FIG. 3. It causes a smoother impact of the nozzle needle 7 on the seat, which will reduce the wear on this site too. The illustrated needle movement curve with its effect on the injection curve is desirable for many combustion chamber designs, at least not disadvantageous for others, and will substantially extend the usable lives of injectors.

FIG. 4 depicts a further partial section in the region of the control sleeve 11 and the upper region of the nozzle needle 7. Here, an annular groove 36 is provided in the nozzle needle 7 above the supply throttle 15 and connected with a controlled supply throttle 39, which is closed by the lower edge of the control sleeve 11 after having travelled a partial stroke 40. The partial stroke 40 is smaller than the stroke of the nozzle needle 7 from the closed position to the opened position. On account of this arrangement, the opening procedure of the nozzle needle 7 in the first phase, i.e. as long as both the supply throttle 15 and the controlled supply throttle 39 are opened, takes place at a low speed. The amount supplied to the control chamber is only slightly smaller than the amount discharged through the discharge throttle 20. However, after having closed the annular groove 36 and, hence, the connection to the controlled supply throttle 39, the supply amount will clearly decrease while the opening speed of the nozzle needle 7 will increase. FIG. 5 shows the effect of this arrangement on the needle movement. There is a flatter rise 43 after the beginning of injection during the pass of the partial stroke 40 of the nozzle needle 7. During the closing procedure of the nozzle needle 7, the control chamber 12 is at first slowly filled merely by the supply throttle 15. After a release of the controlled supply throttle 39, more rapid filling takes place and the needle closure is accelerated. This results in a steeper drop of the needle movement 44 towards the end of injection. Such a needle stroke curve and its effect on the injection curve and, hence, on the combustion procedure will be advantageous in terms of consumption, noise and emissions for a number of engines.

An additional advantage of the illustrated arrangements resides in the reduced control amount which is pressurelessly discharged into the fuel recirculation.

1. A device for the injection of fuel into the combustion chamber of an internal combustion engine, including and injector nozzle and a nozzle needle guided in a longitudinally displaceable manner within the injector nozzle, which nozzle needle is at least partially surrounded by a nozzle prechamber and, for the control of its opening and closing movements, capable of being pressurized in the axial direction by the pressure prevailing in a control chamber filled with fuel, wherein a supply line runs into the control chamber and a discharge line in which a magnetic control valve is arranged leads away from the control chamber wherein the supply line to the control chamber is guided through at least one bore of the nozzle needle, which communicates with the nozzle prechamber via a supply throttle, characterized in that between the control chamber and the nozzle prechamber a further supply throttle is arranged, whose passage cross-section during the pass of at least a partial stroke of the nozzle needle is changeable and/or closable as a function of the stroke of the nozzle needle.

2. A device according to claim 1, characterized in that said further supply throttle is opened during the pass of at least a partial stroke of the nozzle needle and closed outside the at least partial stroke.

3. A device according to claim 1, characterized in that said further supply throttle is opened over a partial stroke, departing from the opened position of the nozzle needle.

4. A device according to claim 1, characterized in that the nozzle needle is guided in a control sleeve and said further supply throttle is formed by a throttle bore running into the bore of the nozzle needle and a supply bore provided in the control sleeve, wherein the throttle bore and the supply bore enter into alignment during the pass of a partial stroke of the nozzle needle.

5. A device according to claim 1, characterized in that the supply bore runs into an annular groove provided on the inner periphery of the control sleeve and can be brought into alignment with an annular groove provided on the outer periphery of the nozzle needle and communicating with the throttle bore.

6. A device according to claim 1, characterized in that the throttle bore runs into an annular groove provided on the outer periphery of the nozzle needle, which annular groove is closed by the lower edge of the control sleeve after having travelled a first partial stroke.

7. A device according to claim 2, characterized in that said further supply throttle is opened over a partial stroke, departing from the opened position of the nozzle needle.

8. A device according to claim 2, characterized in that the nozzle needle is guided in a control sleeve and said further supply throttle is formed by a throttle bore running into the bore of the nozzle needle and a supply bore provided in the control sleeve, wherein the throttle bore and the supply bore enter into alignment during the pass of a partial stroke of the nozzle needle.

9. A device according to claim 3, characterized in that the nozzle needle is guided in a control sleeve and said further supply throttle is formed by a throttle bore running into the bore of the nozzle needle and a supply bore provided in the control sleeve, wherein the throttle bore and the supply bore enter into alignment during the pass of a partial stroke of the nozzle needle.
